(19) United States
(12) Patent Application Publication
(10) Pub. No.: US 2020/0410987 A1
(43) Pub. Date: Dec. 31, 2020

(54) INFORMATION PROCESSING DEVICE, INFORMATION PROCESSING METHOD, PROGRAM, AND INFORMATION PROCESSING SYSTEM

(71) Applicant: Sony Corporation, Tokyo (JP)

(72) Inventor: Emiru TSUNOO, Tokyo (JP)

(73) Assignee: Sony Corporation, Tokyo (JP)

(21) Appl. No.: 16/977,102

(22) PCT Filed: Dec. 28, 2018
(86) PCT No.: PCT/JP2018/048410

§ 371 Date: Sep. 1, 2020

(30) Foreign Application Priority Data
Mar. 8, 2018 (JP) 2018-041394

(51) Int. Cl. G10L 15/08; G10L 15/02; G10L 25/51; H04L 29/08

(52) U.S. Cl. CPC G10L 15/08; G10L 15/02; G10L 2015/088; H04L 67/125; G10L 25/51

(57) ABSTRACT

An information processing device includes an input unit to which a predetermined voice is input, and a determination unit that determines whether or not a voice input after a voice including a predetermined word is input is intended to operate a device.

### TECHNICAL FIELD

The present disclosure relates to an information processing device, an information processing method, a program, and an information processing system.

### BACKGROUND ART

Electronic devices that perform voice recognition have been proposed (see, for example, Patent Documents 1 and 2).

### CITATION LIST

### Patent Document

Patent Document 1: Japanese Patent Application Laid-Open No. 2014-137430

Patent Document 2: Japanese Patent Application Laid-Open No. 2017-191119

### SUMMARY OF THE INVENTION

### Problems to be Solved by the Invention

In such a field, it is desired to prevent voice recognition from being performed on the basis of a speech that is not intended to operate an agent and the agent from malfunctioning.

One of purposes of the present disclosure is to provide an information processing device, an information processing method, a program, and an information processing system that perform processing according to a voice intended to operate an agent in a case where a user speaks the voice, for example.

### Solutions to Problems

The present disclosure is, for example,

an information processing device including

an input unit to which a predetermined voice is input, and

a determination unit that determines whether or not a voice input after a voice including a predetermined word is input is intended to operate a device.

The present disclosure is, for example,

an information processing method including

determining, by a determination unit, whether or not a voice input to an input unit after a voice including a predetermined word is input to the input unit is intended to operate a device.

The present disclosure is, for example,

a program that causes a computer to execute an information processing method including

determining, by a determination unit, whether or not a voice input to an input unit after a voice including a predetermined word is input to the input unit is intended to operate a device.

The present disclosure is, for example,

an information processing system including

a first device and a second device, in which

the first device includes

an input unit to which a voice is input,

a determination unit that determines whether or not a voice input after a voice including a predetermined word is input is intended to operate a device, and

a communication unit that transmits, to the second device, the voice input after the voice including the predetermined word is input in a case where the determination unit determines that the voice is intended to operate the device, and

the second device includes

a voice recognition unit that performs voice recognition on the voice transmitted from the first device.

### Effects of the Invention

According to at least an embodiment of the present disclosure, it is possible to prevent voice recognition from being performed on the basis of a speech that is not intended to operate an agent and the agent from malfunctioning. Note that the effects described here are not necessarily limited, and may be any effects described in the present disclosure. In addition, the contents of the present disclosure are not to be construed as being limited by the exemplified effects.

### BRIEF DESCRIPTION OF DRAWINGS

FIG. 1 is a block diagram illustrating a configuration example of an agent according to an embodiment.

FIG. 2 is a diagram for describing a processing example performed by a device operation intention determination unit according to the embodiment.

FIG. 3 is a flowchart illustrating a flow of processing performed by the agent according to the embodiment.

FIG. 4 is a block diagram illustrating a configuration example of an information processing system according to a modified example.

### MODE FOR CARRYING OUT THE INVENTION

Hereinafter, an embodiment and the like of the present disclosure will be described with reference to the drawings. Note that the description will be made in the following order.

### <Problems to be Considered in Embodiment>

<1. One embodiment>

### <2. Modified Example>

The embodiment and the like to be described below are preferred specific examples of the present disclosure, and the contents of the present disclosure are not limited to the embodiment and the like.

### Problems to be Considered in Embodiment

First, problems to be considered in the embodiment will be described in order to facilitate understanding of the present disclosure. In the present embodiment, an operation on an agent (device) that performs voice recognition will be described as an example. The agent means, for example, a voice output device having a portable size or a voice interaction function of the voice output device with a user. Such a voice output device is also called a smart speaker or the like. Of course, the agent is not limited to the smart speaker and may be a robot or the like. The user speaks a voice to the agent. By performing voice recognition on the voice spoken by the user, the agent executes processing corresponding to the voice and outputs a voice response.

In such a voice recognition system, when the agent recognizes a speech of a user, in a case where the user intentionally speaks to the agent, voice recognition processing should be performed, but in a case where the user does not intentionally speak to the agent, such as a soliloquy and a conversation with another user around, it is desirable not to perform voice recognition. It is difficult for the agent to determine whether or not a speech of a user is for the agent, and in general, voice recognition processing is performed even for a speech that is not intended to operate the agent and an erroneous voice recognition result is obtained in many cases. Furthermore, it is possible to use a discriminator that discriminates between the presence and absence of an operation intention for the agent on the basis of a result of voice recognition, or to use the certainty factor in voice recognition, but there is a problem that the processing amount becomes large.

Incidentally, in a case where a user makes a speech intended to operate the agent, the speech intended to operate the agent is often made after a typical short phrase called an “activation word” is spoken. The activation word is, for example, a nickname of the agent or the like. As a specific example, a user speaks “increase the volume”, “tell me the weather tomorrow”, or the like after speaking the activation word. The agent performs voice recognition on the contents of the speech and executes processing according to the result.

As described above, the voice recognition processing and the processing according to the recognition result are performed on the assumption that the activation word is always spoken in a case where the agent is operated, and all the speeches after the activation word operate the agent. However, according to such a method, in a case where a soliloquy, a conversation with a family member, a noise, or the like that does not intend to operate the agent occurs after the activation word, the agent may erroneously perform voice recognition. As a result, there is a possibility that unintended processing may be executed by the agent in a case where a user makes a speech that is not intended to operate the agent.

Furthermore, in a case of aiming for a more interactive system, or in a case where one time of speech of the activation word enables a continuous speech for a certain period of time thereafter, for example, there is higher possibility that a speech without an operation intention for the agent as described above may occur. The embodiment of the present disclosure will be described in consideration of such problems.

### 1. One Embodiment

### Configuration Example of Agent

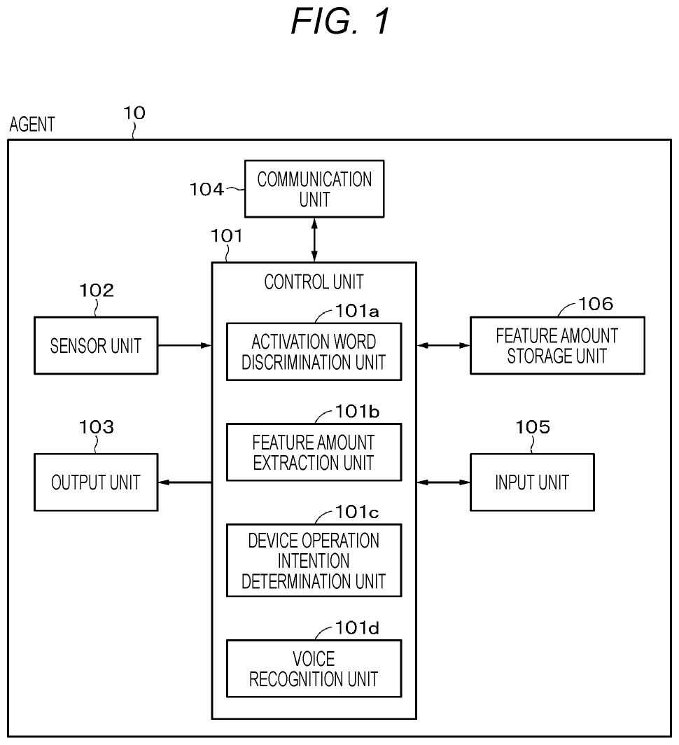

FIG. 1 is a block diagram illustrating a configuration example of an agent (agent 10), which is an example of an information processing device according to the embodiment. The agent 10 is, for example, a small-sized agent that is portable and placed inside a house (indoor). Of course, the place where the agent 10 is placed can be appropriately determined by a user of the agent 10, and the size of the agent 10 need not be small.

The agent 10 includes, for example, a control unit 101, a sensor unit 102, an output unit 103, a communication unit 104, an input unit 105, and a feature amount storage unit 106.

The control unit 101 includes, for example, a central processing unit (CPU) and the like and controls each unit of the agent 10. The control unit 101 includes a read only memory (ROM) in which a program is stored and a random access memory (RAM) used as a work memory when executing the program (note that these are not illustrated).

The control unit 101 includes, as functions thereof, an activation word discrimination unit 101a, a feature amount extraction unit 101b, a device operation intention determination unit 101c, and a voice recognition unit 101d.

The activation word discrimination unit 101a, which is an example of a discrimination unit, detects whether or not a voice input to the agent 10 includes an activation word, which is an example of a predetermined word. The activation word according to the present embodiment is a word including a nickname of the agent 10, but is not limited to this. For example, the activation word can be set by a user.

The feature amount extraction unit 101b extracts an acoustic feature amount of a voice input to the agent 10. The feature amount extraction unit 101b extracts the acoustic feature amount included in the voice by processing having a smaller processing load than voice recognition processing that performs pattern matching. For example, the acoustic feature amount is extracted on the basis of a result of fast Fourier transform (FFT) on a signal of the input voice. Note that the acoustic feature amount according to the present embodiment means a feature amount relating to at least one of a tone color, a pitch, a speech speed, or a volume.

The device operation intention determination unit 101c, which is an example of a determination unit, determines whether or not a voice input after a voice including the activation word is input is intended to operate the agent 10, for example. The device operation intention determination unit 101c then outputs a determination result.

The voice recognition unit 101d performs, for example, voice recognition using pattern matching on an input voice. Note that the voice recognition by the activation word discrimination unit 101a described above only needs to perform matching processing with a pattern corresponding to a predetermined activation word, and thus is processing having a load lighter than the voice recognition processing performed by the voice recognition unit 101d. The control unit 101 executes control based on a voice recognition result by the voice recognition unit 101d.

The sensor unit 102 is, for example, a microphone (an example of an input unit) that detects a speech (voice) of a user. Of course, another sensor may be applied as the sensor unit 102.

The output unit 103 outputs a result of the control executed by the control unit 101 by voice recognition, for example. The output unit 103 is, for example, a speaker device. The output unit 103 may be a display, a projector, or a combination thereof, instead of the speaker device.

The communication unit 104 communicates with another device connected via a network such as the

Internet, and includes components such as a modulation/demodulation circuit and an antenna corresponding to the communication method.

The input unit 105 receives an operation input from a user. The input unit 105 is, for example, a button, a lever, a switch, a touch panel, a microphone, a line-of-sight detection device, or the like. The input unit 105 generates an operation signal in accordance with an input made to the input unit 105, and supplies the operation signal to the control unit 101. The control unit 101 executes processing according to the operation signal.

The feature amount storage unit 106 stores the feature amount extracted by the feature amount extraction unit 101b. The feature amount storage unit 106 may be a hard disk built in the agent 10, a semiconductor memory or the like, a memory detachable from the agent 10, or a combination thereof.

Note that the agent 10 may be driven on the basis of electric power supplied from a commercial power source, or may be driven on the basis of electric power supplied from a chargeable/dischargeable lithium-ion secondary battery or the like.

### Processing Example in Device Operation Intention Determination Unit

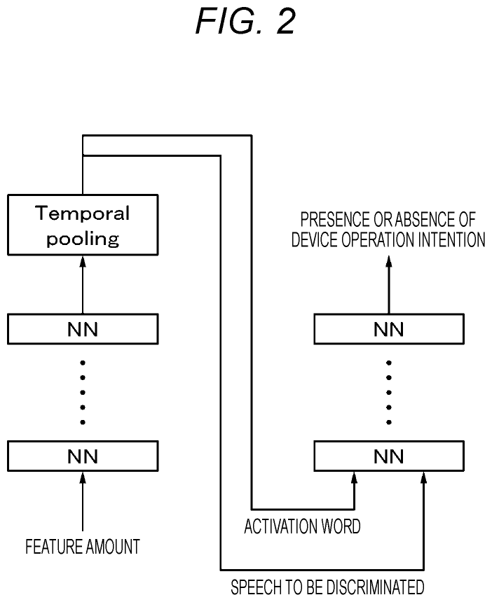

An example of processing in the device operation intention determination unit 101c will be described with reference to FIG. 2. The device operation intention determination unit 101c uses an acoustic feature amount extracted from an input voice and a previously stored acoustic feature amount (acoustic feature amount read from the feature amount storage unit 106) to perform discrimination processing relating to the presence or absence of an operation intention.

In processing at a former stage, conversion processing is performed on the extracted acoustic feature amount by a neural network (NN) of multiple layers, and then processing of accumulating information in a time series direction is performed. For this processing, statistics such as average and variance may be calculated, or a time series processing module such as long short time memory (LSTM) may be used. By this processing, vector information is calculated from each of a previously stored activation word and the current acoustic feature amount, and the vector information is input in parallel to a neural network of multiple layers at a latter stage. In the present example, two vectors are simply concatenated and input as one vector. In a final layer, a two-dimensional value indicating whether or not there is an operation intention for the agent 10 is calculated, and a discrimination result is output by a softmax function or the like.

The device operation intention determination unit 101c described above learns parameters by performing supervised learning with a large amount of labeled data in advance. Learning the former and latter stages in an integrated manner enables more optimal learning of a discriminator. Furthermore, it is also possible to add a constraint to an objective function so that a vector of a result of the processing at the former stage differs greatly depending on whether or not there is an operation intention for the agent.

### Operation Example of Agent

### Outline of Operation

Next, an operation example of the agent 10 will be described. First, an outline of an operation will be described. When recognizing an activation word, the agent 10 extracts and stores an acoustic feature amount of the activation word (a voice including the activation word may be used). In a case where a user speaks the activation word, it is often the case that the speech has an operation intention for the agent 10. Furthermore, in a case where the user speaks with the operation intention for the agent 10, the user tends to speak understandably with a distinct, clear, and comparatively loud voice so that the agent 10 can accurately recognize the voice.

On the other hand, in a soliloquy or a conversation with another person that does not intend to operate the agent 10, a speech is often made more naturally and at a volume and a speech speed that can be understood by humans, including many fillers and stammers.

That is, in the case of the speech with the operation intention for the agent 10, there are many cases where a peculiar tendency is shown as an acoustic feature amount, for example, acoustic feature amounts relating to the activation word include information such as a voice color, a voice pitch, a speech speed, and a volume of the speech with the operation intention of the user for the agent 10. Therefore, by storing these acoustic feature amounts and using these acoustic feature amounts in the processing of discriminating between the presence and absence of the operation intention for the agent 10, it is possible to perform the discrimination with high accuracy. Furthermore, it is possible to perform the discrimination by simple processing as compared with processing of discriminating between the presence and absence of the operation intention for the agent 10 by using voice recognition that performs matching with a large number of patterns. Moreover, it is possible to perform the processing of discriminating between the presence and absence of the operation intention for the agent 10 with high accuracy.

Then, in a case where a speech of the user intended to operate the agent 10 is discriminated, voice recognition (for example, voice recognition performing matching with a plurality of patterns) is performed on a voice of the speech. The control unit 101 of the agent 10 executes processing according to a result of the voice recognition.

### Processing Flow

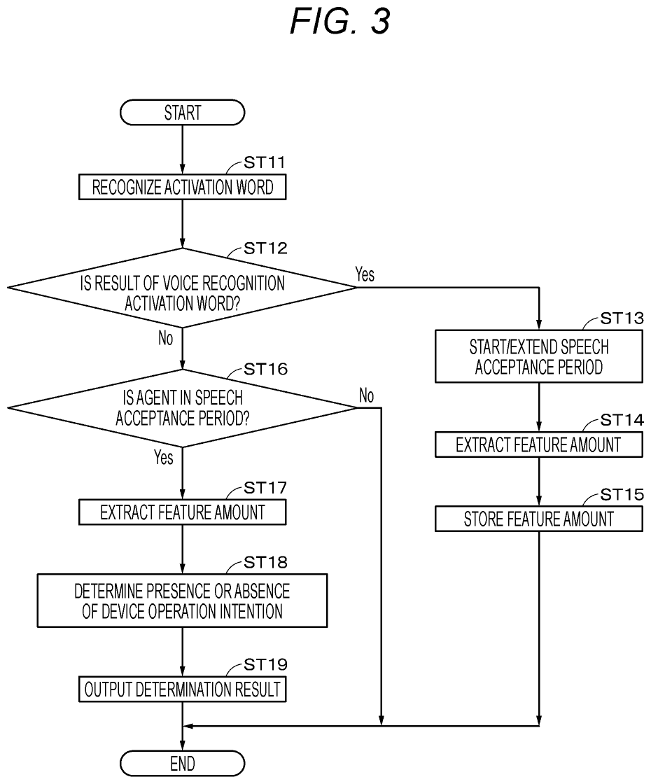

An example of a flow of processing performed by the agent 10 (more specifically, the control unit 101 of the agent 10) will be described with reference to a flowchart of FIG. 3. In step ST11, the activation word discrimination unit 101a performs voice recognition (activation word recognition) for discriminating whether or not a voice input to the sensor unit 102 includes an activation word. The processing then proceeds to step ST12.

In step ST12, it is determined whether or not a result of the voice recognition in step ST11 is the activation word. Here, in a case where the result of the voice recognition in step ST11 is the activation word, the processing proceeds to step ST13.

In step ST13, a speech acceptance period starts. The speech acceptance period is, for example, a period set for a predetermined period (for example, 10 seconds) from a timing when the activation word is discriminated. It is then determined whether or not a voice input during this period is a speech having an operation intention for the agent 10. Note that, in a case where the activation word is recognized after the speech acceptance period is set once, the speech acceptance period may be extended. The processing then proceeds to step ST14.

In step ST14, the feature amount extraction unit 101b extracts an acoustic feature amount. The feature amount extraction unit 101b may extract only an acoustic feature amount of the activation word, or also extract an acoustic feature amount of the voice including the activation word in a case where a voice other than the activation word is included. The processing then proceeds to step ST15.

In step ST15, the acoustic feature amount extracted by the control unit 101 is stored in the feature amount storage unit 106. Then, the processing ends.

A case is considered where, after a user speaks the activation word, a speech that does not include the activation word (there may be a speech with the operation intention for the agent 10 or may be a speech without the operation intention for the agent 10), a noise, or the like is input to the sensor unit 102 of the agent 10. Even in this case, the processing of step ST11 is performed.

Since the activation word is not recognized in the processing of step ST11, it is determined that the result of the voice recognition in step ST11 is not the activation word in the processing of step ST12 and the processing proceeds to step ST16.

In step ST16, it is determined whether or not the agent 10 is in the speech acceptance period. Here, in a case where the agent 10 is not in the speech acceptance period, the processing of determining the operation intention for the agent is not performed, and thus the processing ends. In the processing in step ST16, in a case where the agent 10 is in the speech acceptance period, the processing proceeds to step ST17.

In step ST17, an acoustic feature amount of a voice input during the speech acceptance period is extracted. The processing then proceeds to step ST18.

In step ST18, the device operation intention determination unit 101c determines the presence or absence of the operation intention for the agent 10. For example, the device operation intention determination unit 101c compares the acoustic feature amount extracted in step ST17 with an acoustic feature amount read from the feature amount storage unit 106, and determines that the user has the operation intention for the agent 10 in a case where the degree of coincidence is equal to or higher than a predetermined value. Of course, an algorithm by which the device operation intention determination unit 101c discriminates between the presence and absence of the operation intention for the agent 10 can be appropriately changed. The processing then proceeds to step ST19.

In step ST19, the device operation intention determination unit 101c outputs a determination result. For example, in a case where the device operation intention determination unit 101c determines that the user has the operation intention for the agent 10, the device operation intention determination unit 101c outputs a logical value of “1”, and in a case where the device operation intention determination unit 101c determines that the user has no operation intention for the agent 10, the device operation intention determination unit 101c outputs a logical value of “0”. Then, the processing ends.

Note that, in a case where it is determined that the user has the operation intention for the agent 10, the voice recognition unit 101d performs voice recognition processing on an input voice although the processing is not illustrated in FIG. 3. Then, processing according to a result of the voice recognition processing is performed under control of the control unit 101. The processing according to the result of the voice recognition processing can be appropriately changed in accordance with a function of the agent 10. For example, in a case where the result of the voice recognition processing is “inquiry about weather”, for example, the control unit 101 controls the communication unit 104 to acquire information regarding weather from an external device. The control unit 101 then synthesizes a voice signal on the basis of the acquired weather information, and outputs a voice corresponding to the voice signal from the output unit 103. As a result, the user is informed of the information regarding the weather by voice. Of course, the information regarding the weather may be notified by an image, a combination of an image and voice, or the like.

According to the embodiment described above, it is possible to determine the presence or absence of the operation intention for the agent without waiting for a result of voice recognition processing involving matching with a plurality of patterns. Furthermore, it is possible to prevent the agent from malfunctioning due to a speech without the operation intention for the agent. In addition, by performing recognition on the activation word in parallel, it is possible to discriminate between the presence and absence of the operation intention for the agent with high accuracy.

Furthermore, when the presence or absence of the operation intention for the agent is determined, the voice recognition involving matching with a plurality of patterns is not directly used, and thus it is possible to a determination by simple processing. In addition, even in a case where the function of the agent is incorporated in another device (for example, a television device, white goods, Internet of Things (IoT) device, or the like), a processing load associated with the determination of the operation intention is relatively small, and thus it is easy to introduce the function of the agent to those devices. Furthermore, it is possible to continue accepting a voice without the agent malfunctioning after the activation word is spoken, and thus it is possible to achieve agent operation by more interactive dialogue.

### 2. Modified Example

Although the embodiment of the present disclosure has been specifically described above, the contents of the present disclosure are not limited to the above-described embodiment, and various modifications based on the technical idea of the present disclosure are possible. Hereinafter, modified examples will be described.

### Configuration Example of Information Processing System According to Modified Example

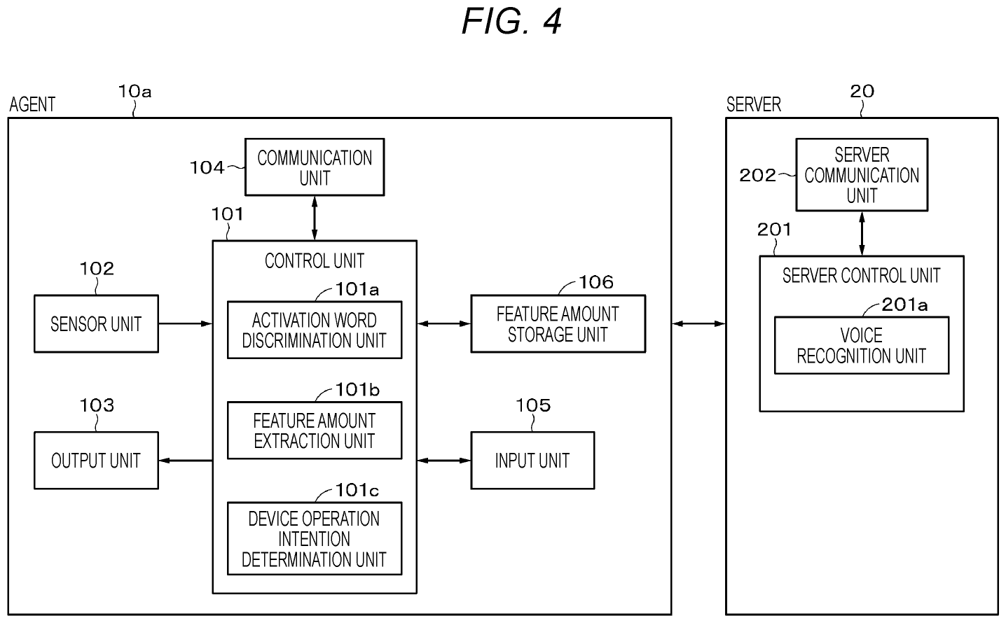

A part of the processing described in the above-described embodiment may be performed on a cloud side. FIG. 4 illustrates a configuration example of an information processing system according to a modified example. Note that, in FIG. 4, components that are the same as or similar to the components in the above-described embodiment are assigned the same reference numerals.

The information processing system according to the modified example includes, for example, an agent 10a and a server 20, which is an example of a cloud. The agent 10a is different from the agent 10 in that the control unit 101 does not have the voice recognition unit 101d.

The server 20 includes, for example, a server control unit 201 and a server communication unit 202. The server control unit 201 is configured to control each unit of the server 20, and has, as a function, a voice recognition unit 201a, for example. The voice recognition unit 201a operates, for example, similarly to the voice recognition unit 101d according to the embodiment.

The server communication unit 202 is configured to communicate with another device, for example, with the agent 10a, and has a modulation/demodulation circuit, an antenna, and the like according to the communication method. Communication is performed between the communication unit 104 and the server communication unit 202, so that communication is performed between the agent 10a and the server 20, and thus various types of data are transmitted and received.

An operation example of the information processing system will be described. The device operation intention determination unit 101c determines the presence or absence of an operation intention for the agent 10a in a voice input during a speech acceptance period. The control unit 101 controls the communication unit 104 in a case where the device operation intention determination unit 101c determines that there is the operation intention for the agent 10a, and transmits, to the server 20, voice data corresponding to the voice input during the speech acceptance period.

The voice data transmitted from the agent 10a is received by the server communication unit 202 of the server 20. The server communication unit 202 supplies the received voice data by the server control unit 201. The voice recognition unit 201a of the server control unit 201 then executes voice recognition on the received voice data. The server control unit 201 transmits a result of the voice recognition to the agent 10a via the server communication unit 202. The server control unit 201 may transmit data corresponding to the result of the voice recognition to the agent 10a.

In a case where voice recognition is performed by the server 20, it is possible to prevent a speech without the operation intention for the agent 10a from being transmitted to the server 20, and thus it is possible to reduce a communication load. Furthermore, since it is not necessary to transmit the speech without the operation intention for the agent 10a to the server 20, there is an advantage for a user from a viewpoint of security. That is, it is possible to prevent the speech without the operation intention from being acquired by another person due to unauthorized access or the like.

As described above, a part of the processing of the agent 10 according to the embodiment may be performed by the server.

### Other Modified Examples

When an acoustic feature amount of an activation word is stored, the latest acoustic feature amount may be used while always overwritten, or the acoustic feature amount of a certain period may be accumulated and all of the accumulated acoustic feature amounts may be used. By always using the latest acoustic feature amount, it is possible to flexibly cope with changes that occur daily, such as a change of users, a change in the voice due to a cold, and a change in the acoustic feature amount (for example, sound quality) due to wearing a mask, for example. On the other hand, in a case where the accumulated acoustic feature amounts are used, there is an effect of minimizing an error of the activation word discrimination unit 101a, which may occur rarely. Furthermore, not only the activation word but also a speech determined to have an operation intention for an agent may be accumulated. In that case, various speech variations can be absorbed. In this case, a corresponding acoustic feature amount may be stored in association with one of activation words.

Furthermore, as a variation of learning, in addition to a method of learning parameters of the device operation intention determination unit 101c in advance as in the embodiment, it is also possible to perform further learning by information such as other modal information each time a user uses the agent. For example, an imaging device is applied as the sensor unit 102 to enable face recognition and line-of-sight recognition. In a case where the user is facing the agent and clearly has the operation intention for the agent, the learning may be performed in combination with a face recognition result or a line-of-sight recognition result with label information such as “the agent operation intention is present”, along with an actual speech of the user. In addition, the learning may be performed in combination with a result of recognition of raising a hand or a result of contact detection by a touch sensor.

Although the sensor unit 102 is taken as an example of the input unit in the above-described embodiment, the input unit is not limited to this. The device operation intention determination unit may be provided in the server, and in this case, the communication unit and a predetermined interface function as the input unit.

The configuration described in the above-described embodiment is merely an example, and the configuration is not limited to this. It goes without saying that additions and deletions of the configuration or the like may be made without departing from the spirit of the present disclosure. The present disclosure can be implemented in any form such as a device, a method, a program, and a system. Furthermore, the agent according to the embodiment may be incorporated in a robot, a home electric appliance, a television, an in-vehicle device, an IoT device, or the like.

The present disclosure may adopt the following configurations.

(1)

An information processing device including

an input unit to which a predetermined voice is input, and

a determination unit that determines whether or not a voice input after a voice including a predetermined word is input is intended to operate a device.

(2)

The information processing device according to (1), further including

a discrimination unit that discriminates whether or not the predetermined word is included in the voice.

(3)

The information processing device according to (2), further including

a feature amount extraction unit that extracts at least an acoustic feature amount of the word in a case where the voice includes the predetermined word.

(4)

The information processing device according to (3), further including

a storage unit that stores the acoustic feature amount of the word extracted by the feature amount extraction unit.

(5)

The information processing device according to (4), in which

the acoustic feature amount of the word extracted by the feature amount extraction unit is stored while a previously stored acoustic feature amount is overwritten.

(6)

The information processing device according to (4), in which

the acoustic feature amount of the word extracted by the feature amount extraction unit is stored together with a previously stored acoustic feature amount stored.

(7)

The information processing device according to any of (1) to (6), further including

a communication unit that transmits, to another device, the voice input after the voice including the predetermined word is input in a case where the determination unit determines that the voice is intended to operate the device.

(8)

The information processing device according to any of (1) to (7), in which

the determination unit determines, on the basis of an acoustic feature amount of the voice input after the voice including the predetermined word is input, whether or not the voice is intended to operate the device.

(9)

The information processing device according to (8), in which

the determination unit determines, on the basis of an acoustic feature amount of a voice input during a predetermined period from a timing when the predetermined word is discriminated, whether or not the voice is intended to operate the device.

(10)

The information processing device according to (8) or (9), in which

the acoustic feature amount is a feature amount relating to at least one of a tone color, a pitch, a speech speed, or a volume.

(11)

An information processing method including

determining, by a determination unit, whether or not a voice input to an input unit after a voice including a predetermined word is input to the input unit is intended to operate a device.

(12)

A program that causes a computer to execute an information processing method including

determining, by a determination unit, whether or not a voice input to an input unit after a voice including a predetermined word is input to the input unit is intended to operate a device.

(13)

An information processing system including

a first device and a second device, in which

the first device includes

an input unit to which a voice is input,

a determination unit that determines whether or not a voice input after a voice including a predetermined word is input is intended to operate a device, and

a communication unit that transmits, to the second device, the voice input after the voice including the predetermined word is input in a case where the determination unit determines that the voice is intended to operate the device, and

the second device includes

a voice recognition unit that performs voice recognition on the voice transmitted from the first device.

### REFERENCE SIGNS LIST

10 Agent
20 Server
101 Control unit
101a Activation word discrimination unit
101b Feature amount extraction unit
101c Device Operation Intention Determination Unit
101d, 201a Voice recognition unit
104 Communication unit
106 Feature amount storage unit

1. An information processing device comprising:
an input unit to which a predetermined voice is input; and
a determination unit that determines whether or not a voice input after a voice including a predetermined word is input is intended to operate a device.

2. The information processing device according to claim 1, further comprising
a discrimination unit that discriminates whether or not the predetermined word is included in the voice.

3. The information processing device according to claim 2, further comprising
a feature amount extraction unit that extracts at least an acoustic feature amount of the word in a case where the voice includes the predetermined word.

4. The information processing device according to claim 3, further comprising
a storage unit that stores the acoustic feature amount of the word extracted by the feature amount extraction unit.

5. The information processing device according to claim 4, wherein
the acoustic feature amount of the word extracted by the feature amount extraction unit is stored while a previously stored acoustic feature amount is overwritten.

6. The information processing device according to claim 4, wherein
the acoustic feature amount of the word extracted by the feature amount extraction unit is stored together with a previously stored acoustic feature amount stored.

7. The information processing device according to claim 1, further comprising
a communication unit that transmits, to another device, the voice input after the voice including the predetermined word is input in a case where the determination unit determines that the voice is intended to operate the device.

8. The information processing device according to claim 1, wherein
the determination unit determines, on a basis of an acoustic feature amount of the voice input after the voice including the predetermined word is input, whether or not the voice is intended to operate the device.

9. The information processing device according to claim 8, wherein
the determination unit determines, on a basis of an acoustic feature amount of a voice input during a predetermined period from a timing when the predetermined word is discriminated, whether or not the voice is intended to operate the device.

10. The information processing device according to claim 8, wherein
the acoustic feature amount is a feature amount relating to at least one of a tone color, a pitch, a speech speed, or a volume.

11. An information processing method comprising
determining, by a determination unit, whether or not a voice input to an input unit after a voice including a predetermined word is input to the input unit is intended to operate a device.

12. A program that causes a computer to execute an information processing method comprising determining, by a determination unit, whether or not a voice input to an input unit after a voice
including a predetermined word is input to the input unit is intended to operate a device.

13. An information processing system comprising:
a first device; and a second device, wherein
the first device includes
an input unit to which a voice is input,
a determination unit that determines whether or not a voice input after a voice including a predetermined word is input is intended to operate a device, and
a communication unit that transmits, to the second device, the voice input after the voice including the predetermined word is input in a case where the determination unit determines that the voice is intended to operate the device, and
the second device includes
a voice recognition unit that performs voice recognition on the voice transmitted from the first device.
